(19) United States
(12) Patent Application Publication
(10) Pub. No.: US 2018/0231444 A1
(43) Pub. Date: Aug. 16, 2018

(54) LOAD CONTROLLED TESTING OF SHEAR CUTTERS

(71) Applicant: VAREL INTERNATIONAL IND., L.P., Carrollton, TX (US)

(72) Inventor: Federico Bellin, Tomball, TX (US)

(21) Appl. No.: 15/429,628

(22) Filed: Feb. 10, 2017

(51) Int. Cl. G01N 3/58; E21B 10/567; G01N 3/02

(52) U.S. Cl. CPC G01N 3/58; E21B 10/567; G01N 2203/0048; G01N 2203/0053; G01N 3/02

(57) ABSTRACT

A method for testing a shear cutter includes: plunging the shear cutter into a rotating target cylinder by a first depth of cut (DOC) while measuring or controlling a first force exerted on the shear cutter; moving the plunged shear cutter across the rotating target cylinder for a first pass; plunging the shear cutter into the rotating target cylinder by a second DOC while controlling a second force exerted on the shear cutter; and moving the plunged shear cutter across the rotating target cylinder for a second pass. The second force is controlled to be equal to the first force. The second DOC is less than the first DOC.

### BACKGROUND OF THE DISCLOSURE

### Field of the Disclosure

The present disclosure generally relates to load controlled testing of shear cutters.

### Description of the Related Art

U.S. Pat. No. 8,453,497 discloses a fixture for holding a cutter for a vertical turret lathe including a block with a blind hole. A cutter with an indenter on its distal end may be secured within the hole such that a portion of the indenter comprises a positive rake angle. A method for testing cutters may comprise securing a cutter on a fixture of a vertical turret lathe which has a cutting material positioned adjacent the cutter. The cutting material may be rotated around a rotational axis at a constant rotational velocity. The fixture may be urged laterally such that the cutter progressively moves towards a periphery of the cutting material. The rotational velocity may be decreased as the cutter moves laterally to maintain a relative constant linear velocity between the cutting material and the cutter.

U.S. Pat. App. Pub. No. 2011/0148021 discloses a target cylinder and a method for fabricating the target cylinder. The target cylinder includes a first end, a second end, and a sidewall extending from the first end to the second end. At least one of the second end and the sidewall is an exposed portion that makes contact with a superhard component to determine at least one property of the superhard component. The exposed portion comprises at least one soft material and at least one hard material that is interveningly positioned between or within the soft material in a predetermined and repeatable pattern. In one embodiment, the differential of the unconfined compressive strength between the hard material and the soft material ranges from about 1,000 psi to about 60,000 psi.

U.S. Pat. App. Pub. No. 2013/0067985 discloses a method and apparatus for testing the abrasive wear resistance of PDC cutters or other superhard materials. The method includes obtaining a first cutter having a first substrate and a first cutting table coupled thereto and obtaining a second cutter having a second substrate and a second cutting table coupled thereto. The method also includes positioning a surface of the first cutting table in contact with a surface of the second cutting table. The method also includes rotating at least one of the first cutters and the second cutters where at least a portion of the first and/or second cutting tables is removed. The method includes determining the amount of first and/or second cutting table removed. The apparatus includes a first holder coupled to the first cutter and a second holder coupled to the second cutter, where at least one holder rotates circumferentially.

U.S. Pat. App. Pub. No. 2013/0239652 discloses a target cylinder, a method for testing a superhard component thereon, and a method for selecting an untested component for use in field applications. The target cylinder includes a first end, a second end, and a side wall extending from the first end to the second end. At least one of the second end and the sidewall is an exposed portion that makes contact with the superhard component to determine at least one property of the superhard component. The target cylinder is formed from a first material evenly distributed throughout a second material. Upon testing superhard components at one or more impact frequencies, untested superhard components are selected based upon field anticipated impact frequencies.

U.S. Pat. App. Pub. No. 2014/0250973 discloses a system and a method of testing a superabrasive cutter. The system of testing a superabrasive cutter may include a spinning wheel holding the superabrasive cutter; a rock feeding into a rotation of the superabrasive cutter on the spinning wheel; and a plurality of sensors operably attaching to the spinning wheel and the rock to detect properties of the superabrasive cutter. The method of testing a superabrasive cutter may include steps of attaching a superabrasive cutter to a spinning wheel; moving a rock into a rotation of the superabrasive cutter on the spinning wheel; and communicably coupling a first sensor to the superabrasive cutter.

U.S. Pat. App. Pub. No. 2015/0075252 discloses methods and techniques for determining wear abrasion resistance of superhard components, such as cutters used in down-hole drilling tools. The methods and techniques produce an efficiency ratio of a superhard component through data obtained from a vertical turret lathe test. The efficiency ratio is the ratio between the volume of a target cylinder removed by the superhard component during the vertical turret lathe test and the normal force applied onto the superhard component by the target cylinder. The efficiency ratio is indicative of the energy efficiency of the superhard component.

### SUMMARY OF THE DISCLOSURE

The present disclosure generally relates to load controlled testing of shear cutters. In one embodiment, a method for testing a shear cutter includes: plunging the shear cutter into a rotating target cylinder by a first depth of cut (DOC) while measuring or controlling a first force exerted on the shear cutter; moving the plunged shear cutter across the rotating target cylinder for a first pass; plunging the shear cutter into the rotating target cylinder by a second DOC while controlling a second force exerted on the shear cutter; and moving the plunged shear cutter across the rotating target cylinder for a second pass. The second force is controlled to be equal to the first force. The second DOC is less than the first DOC.

In another embodiment, a vertical turret lathe (VTL) for testing a shear cutter includes: a frame; a turntable mounted to the frame and operable to rotate a target cylinder; a track mounted to the frame; a runner movable along the track; a head; a plunger operable to raise and lower the head relative to the turntable; and a depth of cut (DOC) actuator. The DOC actuator includes an inclined block mounted to the head; a slider movable along the inclined block and having a pocket for receiving the shear cutter; a piston and cylinder assembly linking the slider to the head; and a hydraulic circuit operable to maintain a constant load on the slider while allowing the slider to move along the inclined block.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIGS. 1 and 2 illustrate commencement of a vertical turret lathe (VTL) test by engagement of a shear cutter with a target cylinder, according to one embodiment of the present disclosure.

FIGS. 3 and 4 illustrate the shear cutter being engaged with the target cylinder for a second pass of the VTL test.

FIGS. 5 and 6 illustrate the shear cutter being engaged with the target cylinder for termination of the VTL test.

FIG. 7 illustrates the controlled loading exerted on the cutter during the VTL test.

### DETAILED DESCRIPTION

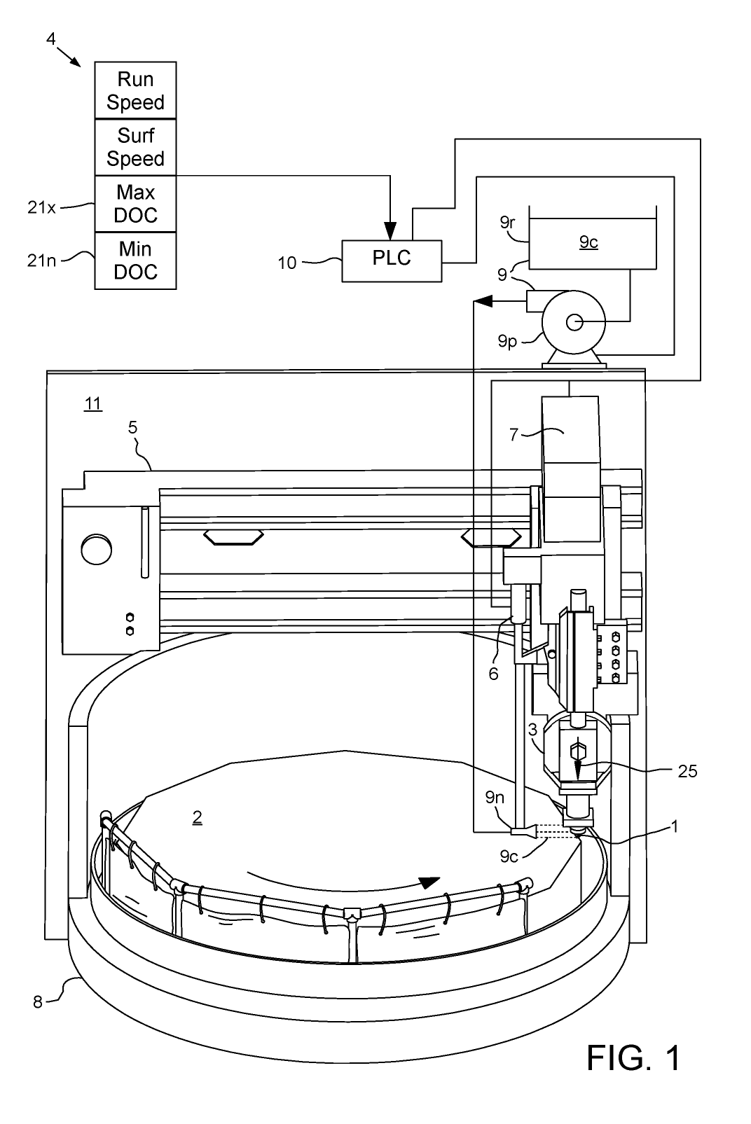

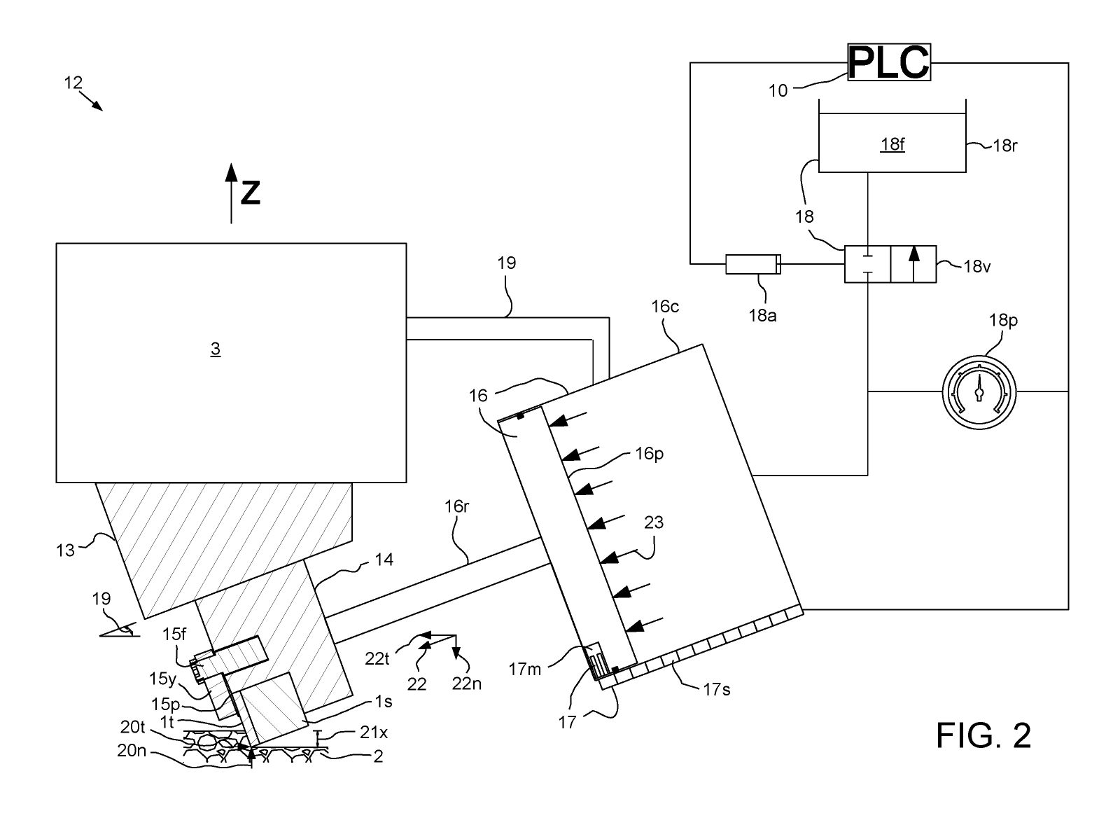

FIGS. 1 and 2 illustrate commencement of a vertical turret lathe (VTL) test by engagement of a shear cutter 1 with a target cylinder 2, according to one embodiment of the present disclosure. To prepare for commencement of the test, the shear cutter 1 may be linked to a head 3 of the VTL 4. The VTL 4 may include the head 3, a track 5, a plunger 6, a runner 7, a turntable 8, a cooling system 9, a programmable logic controller (PLC) 10, a frame 11, and a depth of cut (DOC) actuator 12.

The track 5 and turntable 8 may be mounted to the frame 11. The runner 7 may be movable along the track 5 by operation of a track actuator (not shown), such as a rack and pinion. The rack may extend along the track 5 and the pinion motor may be mounted to the runner 7. The pinion motor may be operated by the PLC 10 via a control line or electric cable. The plunger 6 may be a piston and cylinder assembly having an upper end connected to the runner 7 and a lower end connected to the head 3. The plunger 6 may be operated by the PLC 10 via a control line or electric cable to raise and lower the head 3 relative to the turntable 8. Each of the track actuator and the plunger 6 may also include a position sensor in communication with the PLC 10. The target cylinder 2 may be mounted on the turntable 8. The turntable 8 may include a motor (not shown) for rotating the target cylinder 2 relative to the head 3. The turntable 8 may also include a tachometer (not shown) in communication with the PLC 10. The target cylinder 2 may be made from hard natural rock, such as granite, marble, or sandstone.

Alternatively, the target cylinder 2 may be a synthetic composite having a matrix of concrete and plates of hard natural rock or synthetic ceramic disposed about the matrix in a pattern. The concrete may include cement, such as Portland cement, reinforced with quartzite sand. Alternatively, the rock or ceramic may be dispersed throughout the cement as large particles.

The cooling system 9 may include a reservoir 9r, a pump 9p, a nozzle 9n, and a plurality of fluid conduits. The reservoir 9r and pump 9p may be mounted to the frame 11 and the nozzle 9n may be mounted to the head 3 or the plunger 6. A supply conduit may connect the reservoir 9r to an inlet of the pump 9p and a discharge conduit may connect an outlet of the pump to the nozzle 9n. The discharge conduit may be flexible, such as a hose, to accommodate movement of the head 3 relative to the runner 7 and movement of the runner 7 relative to the frame 11. A quantity of coolant 9c may be disposed in the reservoir 9r. The coolant 9c may be a liquid, such as water, refined oil, synthetic oil, or blended oil. The nozzle 9n may be disposed in proximity to the mounted shear cutter 1 and aimed thereat to spray coolant 9c onto the shear cutter 1. The PLC 10 may be in communication with the pump 9p via a control line or electric cable for selectively activating and deactivating the pump. If the coolant 9c is oil, the turntable 8 may have a sump and a recycle pump for returning the oil to the reservoir 9r.

Alternatively, the VTL test may be performed without coolant (aka dry) and the cooling system 9 may be omitted or deactivated.

Alternatively, the nozzle 9n may be mounted to the frame 11. Alternatively, the nozzle 9n may be aimed to spray the coolant onto the target cylinder 2 instead of onto the shear cutter 1, thereby indirectly cooling the shear cutter. Alternatively, the reservoir 9r may be omitted, the coolant 9c may be air instead of water, and the cooling system 9 may include a compressor instead of the pump 9p.

Also in preparation for commencement of the test, one or more parameters may be input to the PLC 10. The parameters may include maximum DOC 21x, minimum DOC 21n, surface speed (Surf Speed) of the turntable 8 and/or a speed of the runner 7 (Run Speed). During testing, the PLC 10 may utilize measurements from the position sensor of the track actuator and may adjust an angular speed of the turntable motor so that the target cylinder rotates at a constant surface speed relative to the shear cutter 1. The surface speed may range between one hundred and six hundred fifty feet per minute (thirty and one hundred ninety-eight meters per minute). The maximum DOC 21x may range between one-half millimeter and five millimeters. The minimum DOC 21n may be greater than zero and less than or equal to a fraction of the maximum DOC 21x, such as one-tenth, one-twentieth, or one-fiftieth. The minimum DOC 21n may be input manually or the PLC 10 may automatically calculate it using the maximum DOC.

The DOC actuator 12 may include an inclined block 13, a slider 14, a clamp 15, a piston and cylinder assembly (PCA) 16, a position sensor 17, a hydraulic circuit 18, and a bracket 19. The inclined block 13 may be mounted to a bottom of the head 3. The inclined block 13 may have a bottom inclined at an angle 19 relative to a horizontal plane. The inclination angle 19 may range between five and forty-five degrees. The slider 14 may have a top inclined at the inclination angle 19. The slider 14 may be movable along the inclined block 13. A guide (not shown), such as a tongue and groove, may transversely connect the slider 14 to the block 13. An interface between the inclined block 13 and the slider 14 may be lubricated by the coolant 9n or grease.

The bracket 19 may pivotally connect the cylinder 16c of the PCA 16 to the head 3. The piston 16p of the PCA 16 may be disposed in the cylinder 16c, may be longitudinally movable relative thereto, and may carry a seal engaged with an inner surface of the cylinder, thereby dividing the PCA into an upper hydraulic chamber and a lower atmospheric chamber. The piston 16p may also carry a permanent magnet 17m of the position sensor 17. An array of Hall effect sensors 17s of the position sensor 17 may be mounted to the cylinder 17c and an electric cable may connect the array to the PLC 10. The piston rod 16r of the PCA 16 may extend through a bottom of the cylinder 16c and may mount or pivotally connect the slider 14 to the piston 16p.

The shear cutter 1 may be mounted to a pocket formed in the slider 14, such as by the clamp 15. The pocket may be configured such that the shear cutter 1 engages the target cylinder 2 at a positive back rake angle. The back rake angle may correspond to the inclination angle 19. The shear cutter 1 may include a cutting table 1t attached to a cylindrical substrate 1s. The cutting table 1t may be circular and the substrate 1s may be a circular cylinder. The cutting table 1t may be made from a superhard material, such as polycrystalline diamond (PCD), attached to a hard substrate, such as a cermet, thereby forming a compact, such as a polycrystalline diamond compact (PDC). The cermet may be a cemented carbide, such a group VIIIB metal-carbide, such as cobalt-tungsten carbide. The cutting table 1t may have an interface with the substrate 1s and a cutting face opposite to the interface. The cutting table 1t may be non-treated or thermally stable.

Alternatively, the shear cutter 1 may be oval. Alternatively, the superhard material may be cubic boron nitride or impregnated diamond.

The clamp 15 may include a threaded fastener 15f screwed into the slider 14, a yoke 15y disposed onto the fastener, and a nut 15n for securing the yoke onto the fastener. The clamp 15 may further include a pad 15p disposed between the yoke 15y and the shear cutter 1 for evenly distributing a clamping force along the cutting table it.

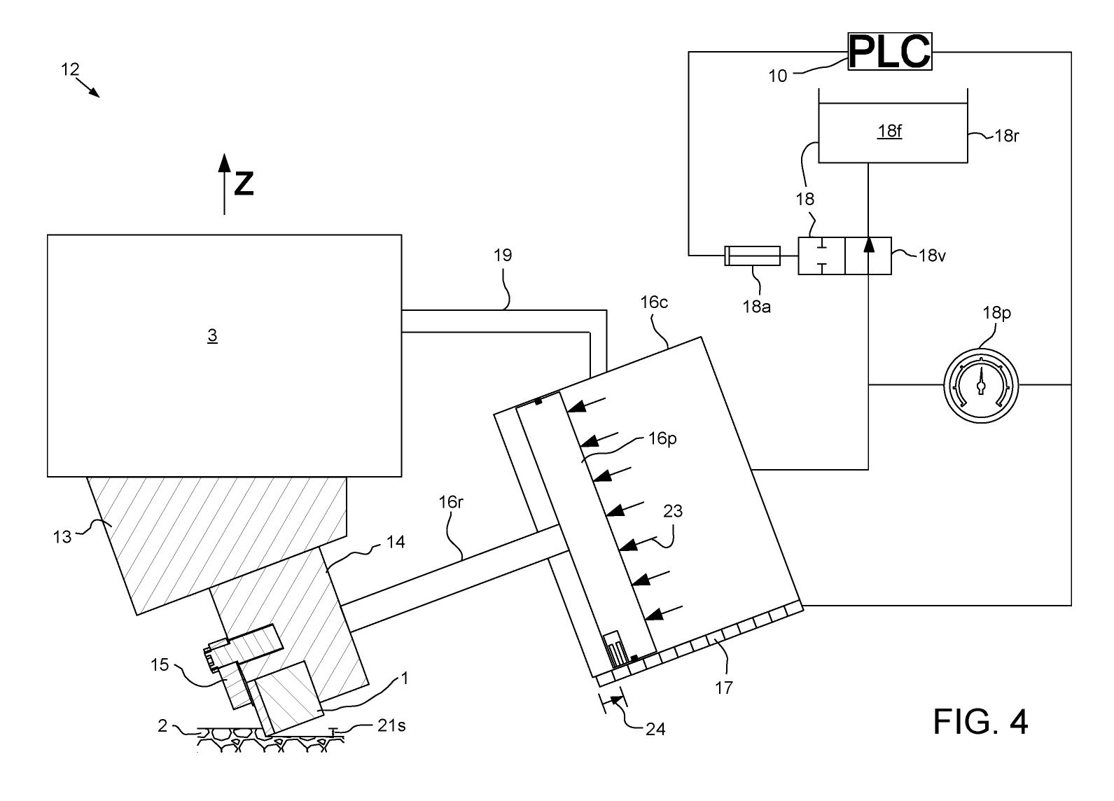

The hydraulic circuit 18 may include a pressure sensor 18p, a reservoir 18r, a bleed valve 18v, an actuator 18a, and a fluid conduit. The hydraulic circuit 18 may be mounted to the head 3. The fluid conduit may connect the reservoir 18r to the hydraulic chamber of the PCA and the bleed valve 18v and pressure sensor 18p may be assembled as part of the fluid conduit. The bleed valve 18v may be located in the fluid conduit between the pressure sensor 18p and the reservoir 18r such that the pressure sensor is always in fluid communication with the hydraulic chamber of the PCA 16. Hydraulic fluid 18f may fill the hydraulic chamber of the PCA 16, the fluid conduit, and a portion of the reservoir 18r. The actuator 18a may also be connected to a valve member of the bleed valve 18v for selectively operating the bleed valve between a closed position (shown) and an open position (FIG. 4). The actuator 18a may be electric, pneumatic, or hydraulic. The PLC 10 may be in communication with the actuator 18a and the pressure sensor 18p via a control line and/or electric cable.

Alternatively, the hydraulic circuit 18 may be mounted to the runner 7 or the frame 11 and the fluid conduit may be flexible, such as a hose, to accommodate movement of the head 3 relative to the runner 7 and/or movement of the runner 7 relative to the frame 11.

Once the preparations have been completed, the test may begin. The turntable 8 may be activated to rotate the target cylinder 2. The PLC 10 may operate the track actuator to position the shear cutter 1 into alignment with an outer surface of the target cylinder 2. The PLC 10 may then activate the pump 9p so that coolant 9c is sprayed onto the shear cutter 1. The PLC 10 may then operate the plunger 6 to lower the head 3 until the shear cutter 1 engages the outer surface of the target cylinder 2. The PLC 10 may continue to operate the plunger 6 to press the shear cutter into the target cylinder 2 until the maximum DOC is reached. The target cylinder 2 may exert a normal force 20n against the shear cutter 1 along the vertical axis (shown as Z-axis). The target cylinder 2 may also exert a transverse force 20t against the shear cutter 1.

For the initial plunge, the PLC 10 may keep the bleed valve 18v closed, thereby hydraulically locking the slider 14 in place along the inclined block 13 and ensuring that the actual DOC equals the maximum DOC 21x. Components of the target cylinder forces 20t,f may push the slider 14 toward the cylinder 16c and may be resisted by a control force 22 having a normal component 22n and a transverse component 22t. The control force 22 may be generated by control pressure 23 in the hydraulic chamber of the PCA 16 exerted on the piston 16p. The PLC 10 may measure and record the control pressure 23 using the pressure sensor 18p.

Once the shear cutter 1 has penetrated the target cylinder 2 to the maximum DOC 21x, the PLC 10 may lock the plunger 6 and may then operate the track actuator to move the head 3 and shear cutter 1 radially inward along a top of the target cylinder 2 as the target cylinder rotates relative thereto for a first pass. The cutter 1 may shear material from the target cylinder 2 during the first pass.

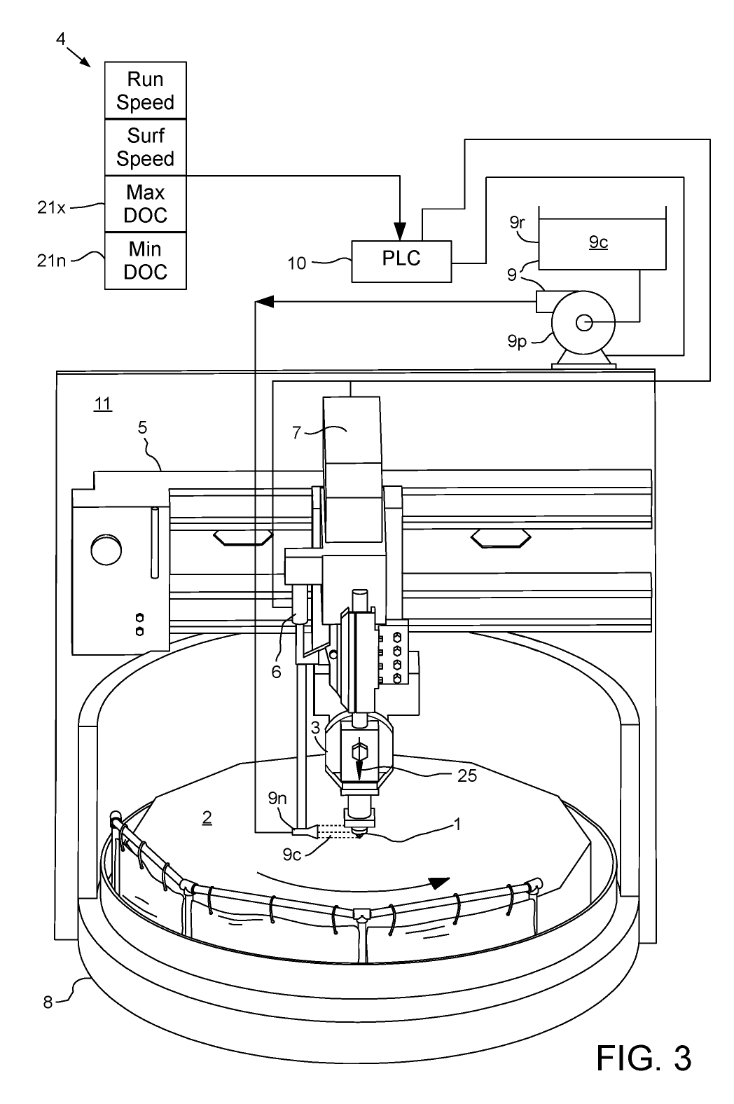

FIGS. 3 and 4 illustrate the shear cutter 1 being engaged with the target cylinder 2 for a second pass of the VTL test. The first pass may be complete once the shear cutter 1 has reached a center of the target cylinder 2. The PLC 10 may then halt the track actuator, unlock the plunger 6, and operate the plunger to further advance the shear cutter 1 into the target cylinder 2. The PLC 10 may monitor the pressure in the hydraulic chamber of the PCA 16 and compare it to the control pressure 23. The PLC 10 may generate a maximum threshold pressure which is one-half percent to ten percent greater than the control pressure 23 and a minimum threshold pressure which is one-half percent to ten percent less than the control pressure.

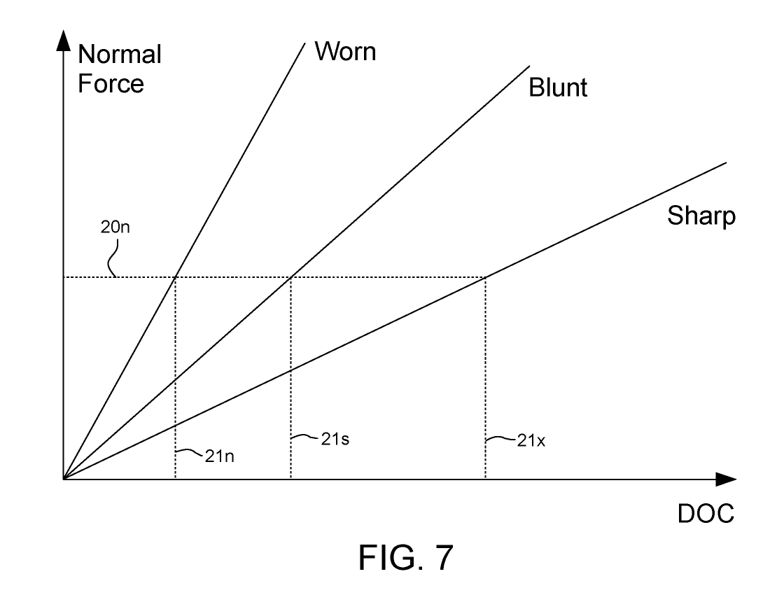

Since the shear cutter 1 may have become blunt during the first pass, a greater normal force 20n may be required to plunge the shear cutter 1 into the target cylinder (FIG. 7). As the plunger 6 presses the shear cutter 1 into the target cylinder 2, the pressure in the hydraulic chamber of the PCA 16 may reach the maximum threshold pressure and the PLC 10 may open the bleed valve 18v to prevent the chamber pressure from exceeding the maximum threshold pressure and close the bleed valve 18v once the chamber pressure reaches the minimum threshold pressure, thereby maintaining a constant control force 22 on the shear cutter 1. The PLC 10 may repeat opening and closing of the bleed valve 18v as many times as necessary while the plunger 6 is pressing the shear cutter 1 into the target cylinder 2 until the plunger has stroked to the maximum DOC.

As the hydraulic fluid 18f bleeds into the reservoir 18r, the slider 14 may then be free to move 24 along the inclined block 13 toward the cylinder 16c, thereby resulting in the actual DOC 21s being less than the maximum DOC 21x. Once the plunger 6 has stroked to the maximum DOC 21x, the PLC 10 may close the bleed valve 18v (if not closed already). The PLC 10 may measure this movement 24 using the position sensor 17 and determine the actual DOC 21s using the maximum DOC 21x, the measured movement 24, the angle 19, and trigonometry. The PLC 10 may then compare the actual DOC 21s to the minimum DOC 21n. The PLC 10 may then reverse operation of the track actuator to move the shear cutter 1 radially inward along the target cylinder 2 for a second pass. The bleed valve 18v may remain closed during the second pass. The cutter 1 may shear material from the target cylinder 2 during the second pass.

It is expected that the plunging force 25 will remain constant and the normal component of the control force 22 is constant due to control by the PLC 10, thereby resulting in the normal force 20n exerted on the shear cutter 1 remaining constant (FIG. 7).

The difference between the actual DOC 21s shown in FIG. 4 and that 21x shown in FIG. 2 is dramatic for illustrative purpose. In actuality, this difference may not be realized after one pass but after several passes. The operation discussed above for regulating the control pressure 23 may be repeated for each subsequent plunging and pass after the first plunging and pass.

Alternatively, once the shear cutter 1 has reached the center of the target cylinder 2, the PLC 10 may operate the plunger 6 to raise the head 3 and the shear cutter 1 from the target cylinder 2, operate the track actuator to move the head and shear cutter back to the outer surface of the target cylinder, and then operate the plunger to lower the head and shear cutter into engagement with the target cylinder instead of plunging the shear cutter at the center of the target cylinder and having to reverse the track actuator. Regulation of the control pressure 23 may be the same for this alternative as discussed above.

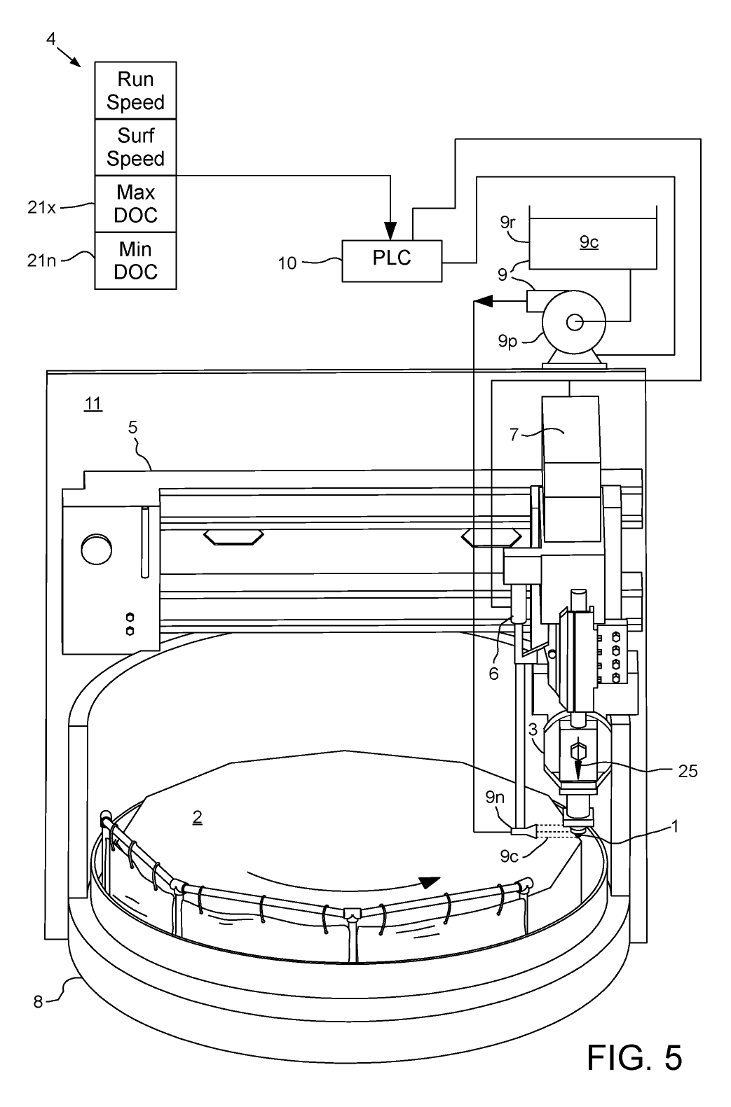

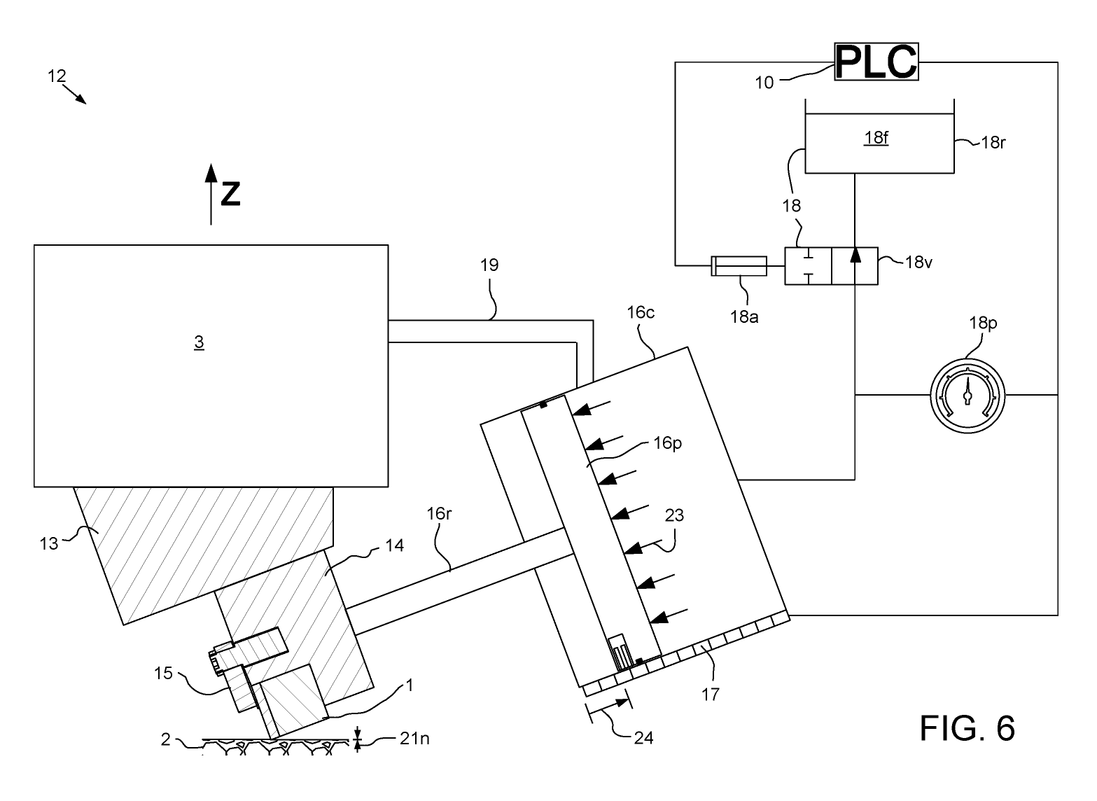

FIGS. 5 and 6 illustrate the shear cutter 1 being engaged with the target cylinder 2 for termination of the VTL test. After several subsequent passes, the shear cutter 1 may become worn and the piston 16p and slider 14 may move 24 far enough along the respective cylinder 16c and inclined block 13 such that the actual DOC becomes less than or equal to the minimum DOC 21n. Once this condition is detected by the PLC 10, the PLC may terminate the test by operating the plunger 6 to raise the head 3, the DOC actuator 12, and the shear cutter 1 from the target cylinder 2, halting rotation of the target cylinder, and shutting off the coolant pump 9p. Performance of the shear cutter 1 may be evaluated by determining the amount, such as volume, of the target cylinder 2 removed by the shear cutter. The performance may be normalized by also determining an amount, such as volume, of the cutting table 1t removed during the test and dividing the amount of the target cylinder removed by the amount of the cutting table removed (aka G ratio). The test may be performed on other types of shear cutters and the test results may be used to compare the types of shear cutters for selection to install the optimum type on a drill bit.

Alternatively, the performance of the shear cutter 1 may be evaluated by using the efficiency ratio discussed above.

Alternatively, a plurality of shear cutters from each type may be tested and an average from each type may be used to compare the different types. Alternatively, the test may be performed on shear cutters of the same or similar type but from different batches to ensure quality.

Advantageously, the load controlled VTL test may more accurately simulate drilling than the prior art discussed above. During drilling with a drill bit (not shown) having a plurality of shear cutters mounted thereon, weight-on-bit (WOB) is controlled while DOC varies. Rate of Penetration (ROP) is measured which is a function of DOC and angular velocity (RPM) of the drill bit. RPM of the drill bit is another controlled variable. Since the simulation is more accurate, the test results should have improved correlation with performance of the shear cutter 1 during a drilling operation. Further, during prior art tests, termination of the test is subjective as opposed to the controlled loading VTL test which uses an objective comparison with a minimum DOC to terminate the test.

Alternatively, the control pressure 23 may be input to the PLC 10 instead of the maximum DOC and the pressure may be regulated by the PLC during the initial plunge of the shear cutter 1 into the target cylinder 2. Alternatively, a maximum stroke of the piston 16p may be input to the PLC 10 instead of the minimum DOC 21n.

Alternatively, the head 3 may have a load cell mounted thereon and in communication with the PLC 10, the DOC actuator 12 may be omitted and the shear cutter 1 mounted directly to the head, and the PLC 10 may use the position sensor of the plunger 6 and the load cell to perform the load controlled VTL test by halting advancement of the plunger once the control force 22 has been exerted on the shear cutter 1 and monitoring the position sensor to determine DOC.

Alternatively, the pressure in the control chamber of the PCA 16 may be controlled by a pressure regulator or pressure relief valve instead of by the PLC 10 and the bleed valve 18v. A set pressure of the regulator or relief valve may be preset prior to commencement of the test.

While the foregoing is directed to embodiments of the present disclosure, other and further embodiments of the disclosure may be devised without departing from the basic scope thereof, and the scope of the invention is determined by the claims that follow.

1. A method for testing a shear cutter, comprising:
plunging the shear cutter into a rotating target cylinder by a first depth of cut (DOC) while measuring or controlling a first force exerted on the shear cutter;
moving the plunged shear cutter across the rotating target cylinder for a first pass;
plunging the shear cutter into the rotating target cylinder by a second DOC while controlling a second force exerted on the shear cutter; and
moving the plunged shear cutter across the rotating target cylinder for a second pass,
wherein:
the second force is controlled to be equal to the first force, and
the second DOC is less than the first DOC.

2. The method of claim 1, wherein the first DOC is a preset maximum DOC.

3. The method of claim 1, wherein the first force is preset.

4. The method of claim 1, wherein:
the method further comprises:
measuring the second DOC;
comparing the second DOC to a preset minimum DOC; and
terminating the test if the second DOC is less than or equal to the minimum DOC.

5. The method of claim 4, further comprising:
repeating plunging and controlling of the second force, movement of the plunged shear cutter for additional passes, and measurement and comparison of additional DOCs until the measured additional DOC is less than or equal to the minimum DOC; and
determining an amount of material removed from the target cylinder by the shear cutter.

6. The method of claim 1, wherein:
the method is performed using a vertical turret lathe (VTL),
the shear cutter is clamped to a slider,
the slider is movable along an inclined block mounted to a head of the VTL.

7. The method of claim 6, wherein:
a cylinder is mounted to the head,
a piston is disposed in the cylinder,
a piston rod is mounted to the piston and the slider, and
the second force is controlled by controlling pressure in the cylinder.

8. The method of claim 7, wherein the pressure is controlled by bleeding pressure from the cylinder, thereby allowing the slider to move along the inclined ramp.

9. The method of claim 8, wherein the pressure is bled by:
a controller monitoring a pressure sensor in fluid communication with the cylinder, and
the controller selectively opening a closing a bleed valve in fluid communication with the cylinder in response to the monitoring of the pressure sensor.

10. The method of claim 8, further comprising:
measuring a position of the piston; and
determining the second DOC using the measured position of the piston.

11. The method of claim 6, wherein:
the method further comprises spraying coolant on an interface between the cutter and the target cylinder during the plunging and the passes,
the coolant also lubricates an interface between the slider and the inclined block.

12. A vertical turret lathe (VTL) for testing a shear cutter, comprising:
a frame;
a turntable mounted to the frame and operable to rotate a target cylinder;
a track mounted to the frame;
a runner movable along the track;
a head;
a plunger operable to raise and lower the head relative to the turntable; and
a depth of cut (DOC) actuator, comprising:
an inclined block mounted to the head;
a slider movable along the inclined block and having a pocket for receiving the shear cutter;
a piston and cylinder assembly linking the slider to the head; and
a hydraulic circuit operable to maintain a constant load on the slider while allowing the slider to move along the inclined block.

13. The VTL of claim 12, wherein the DOC actuator further comprises a position sensor mounted to the piston and cylinder assembly.

14. The VTL of claim 13, wherein:
The VTL further comprises a programmable logic controller (PLC) for monitoring the position sensor and comparing a measurement therefrom to a preset value, and
the PLC is operable to terminate the test in response to the comparison of the measurement to the preset value.

15. The VTL of claim 14, wherein the PLC is further operable to control the hydraulic circuit.
